(19) United States
(12) Patent Application Publication
(10) Pub. No.: US 2010/0192081 A1
(43) Pub. Date: Jul. 29, 2010

(54) Information processing apparatus, information processing method, and program

(75) Inventors: Satoru Inoue, Tokyo (JP); Nariaki Satoh, Kanagawa (JP); Tsunayuki Ohwa, Kanagawa (JP); Junji Ooi, Tokyo (JP); Shinji Yuhara, Tokyo (JP); Takayuki Usami, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignees: Sony Corporation, Tokyo (JP); Sony Ericsson Mobile Communications Japan, Inc., Tokyo (JP)

(21) Appl. No.: 12/657,520

(22) Filed: Jan. 22, 2010

(30) Foreign Application Priority Data
Jan. 28, 2009 (JP) P2009-016222

(51) Int. Cl. G06F 3/048

(52) U.S. Cl. 715/766; 715/764; 715/784

(57) ABSTRACT

An information processing apparatus including a display section to display a data, an input section to input user input information, a communication section to communicate with a server, and a control section. The control section controls a display of a received message on the display section in accordance with the input information input through the input section. The control section displays, on the display section, a post card in which information included in the received message is laid out on a template selected in advance by the server, and enables a user to judge whether the post card corresponds to a read message or an unread message by displaying the post card corresponding to the read message in different display forms from the post card corresponding to the unread message.

### BACKGROUND OF THE INVENTION

1. Field of the Invention

The present invention relates to an information processing apparatus, an information processing method, and a program. Specifically, the present invention relates to an information processing apparatus, an information processing method, and a program that are applied to a system for displaying image data of a picture or the like taken by a user on a display apparatus such as a remotely-located television, for example.

2. Description of the Related Art

Image data of a picture taken by a user can be transmitted with the image data being attached to a communication message via, e.g., a network. This processing enables the image data to be displayed on a remotely-located display apparatus such as a PC and a television and viewed. It should be noted that a viewing system and transmission/reception of image data via a network in related art are disclosed in Japanese Patent Application Laid-open Nos. 2004-274260 and 2007-52559, for example.

Nowadays, there is used a message transmission/reception system that can perform, when an apparatus receives a message, a reception notification for notifying a user of the fact that the message is received. But, the user cannot get a content of an image attached to the received message without opening the message.

For example, a message list that is a list of received messages is displayed on a display of the apparatus that has received the message. However, the message list only shows titles of the messages and information items on senders of the messages, and therefore the user cannot get the content of the image included in the message. To get the content of the image attached to the message, the user has to select a specific message from the message list and open the message selected.

For example, in a state where a large number of messages to which images are attached are received and listed in the message list, even when the user wants to view only one image among those images, the user has to sequentially select and open the messages one by one and confirm the images attached to the messages one by one. This process causes a problem of increasing a burden on the user.

### SUMMARY OF THE INVENTION

In view of the above-mentioned circumstances, it is desirable to provide an information processing apparatus, an information processing method, and a program that make it possible to efficiently confirm the image attached to the message, which reduce the burden on the user.

According to an embodiment of the present invention, there is provided an information processing apparatus including a display section, an input section, a communication section, and a control section. The display section displays a data. The input section inputs user input information. The communication section communicates with a server. The control section controls a display of a received message on the display section in accordance with the input information input through the input section. The control section displays, on the display section, a post card in which information included in the received message is laid out on a template selected in advance by the server, and enables a user to judge whether the post card corresponds to a read message or an unread message by displaying the post card corresponding to the read message in different display forms from the post card corresponding to the unread message.

Further, in the information processing apparatus according to the embodiment of the present invention, the control section displays the read message as the post card that uses a template corresponding to the read message, the template including image data and a message main body in the message that are laid out thereon, and the control section displays the unread message as the post card that uses a template corresponding to the unread message, the template excluding image data and a message main body in the message.

Further, in the information processing apparatus according to the embodiment of the present invention, the control section displays the unread message as the post card including only message transmission destination information and message transmission source information.

Further, in the information processing apparatus according to the embodiment of the present invention, the control section displays the post card corresponding to the read message and the post card corresponding to the unread message in different sizes.

Further, in the information processing apparatus according to the embodiment of the present invention, the control section displays a plurality of post cards so that the post cards are arranged in a display manner in which at least parts of the plurality of post cards corresponding to a plurality of received messages are overlapped and so that a screen used for setting an application that is a processing program for the message is mixed, as an application setting card, in the plurality of post cards arranged, and in accordance with selection and decision information of one of the post card and the application setting card, the control section enlarges one of the post card and the application setting card selected, the selection and decision information being input from the input section.

Further, in the information processing apparatus according to the embodiment of the present invention, the control section performs a page scrolling processing of rearranging the post cards in accordance with the input information from the input section with the post cards arranged being displayed on the display section.

According to another embodiment of the present invention, there is provided an information processing apparatus including a storage section, a communication section, and a control section. The storage section stores a received message and a template. The communication section communicates with a data display apparatus. The control section provides, in response to a message viewing request from the data display apparatus, the received message stored in the storage section. The control section selects a template corresponding to the received message, associates the selected template with a message, and in response to the message viewing request from the data display apparatus, provides, to the data display apparatus, a post card in which information included in the message is laid out on the selected template.

Further, in the information processing apparatus according to the embodiment of the present invention, the control section provides, to the data display apparatus, a read message as the post card that uses a template corresponding to the read message, the template including image data and a message main body in the message that are laid out thereon, and provides, to the data display apparatus, an unread message as the post card that uses a template corresponding to the unread message, the template excluding image data and a message main body in the message.

According to another embodiment of the present invention, there is provided an information processing method executed in an information processing apparatus. The information processing method includes outputting, by a control section, a message viewing request to a server through a communication section, and obtaining, by the control section, information on a post card in which information in a received message is laid out on a template from the server and displaying, on a display section, the obtained information as the post card, the post card corresponding to a read message having a different display form and being distinguishable from the post card corresponding to an unread message.

According to another embodiment of the present invention, there is provided a program for causing an information processing apparatus to execute an information processing. The program includes causing a control section to output a message viewing request to a server through a communication section, and causing the control section to perform a processing of obtaining information on a post card in which information in a received message is laid out on a template from the server and displaying, on a display section, the obtained information as the post card, the post card corresponding to a read message having a different display form and being distinguishable from the post card corresponding to an unread message.

It should be noted that the program according to the embodiment of the present invention can be provided to a computer system or an information processing apparatus that can execute various program codes, through a storage medium or a communication medium in a computer-readable form. By providing the programs in the computer-readable form, processings in accordance with the programs are implemented on the information processing apparatus or the computer system.

These and other objects, features and advantages of the present invention will become more apparent in light of the following detailed description of best mode embodiments thereof, as illustrated in the accompanying drawings. It should be noted that the system in this specification refers to a logical composite structure of the plurality of apparatuses. Therefore, the apparatuses of respective structures are not limited to be disposed in the same casing.

With the structure according to the embodiments of the present invention, for example, in displaying the received message on the display apparatus such as a television, a post card in which information included in the received message is laid out on the template is obtained from the server and displayed. The post cards displayed have the display forms so that the read messages and the unread messages can be distinguishable from each other. For example, the read message is displayed as the post card including the image data and the message main body in the message, and the unread message is displayed as the post card including only the message transmission destination/source information. By this processing, the user can easily distinguish between the unread message and the read message, and can confirm the message main body and the image without performing the reopening processing of the read message.

### BRIEF DESCRIPTION OF DRAWINGS

FIG. 1 is a diagram showing an example of a structure of an information processing system according to an embodiment of the present invention;

FIG. 2 is a diagram for explaining an example of a structure of data stored in a storage section by a server;

FIG. 3 is a diagram for explaining a communication sequence executed among a data transmission apparatus, the server, and a data display apparatus;

FIG. 4 is a diagram showing a display example of a card list constituted of post cards that uses templates associated with messages by the server;

FIG. 5 is a diagram for explaining a remote controller used on the data display apparatus side and an example of a processing performed by using the remote controller;

FIG. 6 is a diagram for explaining an example of the post card that uses the template corresponding to the message by the server;

FIG. 7 is a diagram for explaining an example of a structure of an application setting card and used processings;

FIG. 8 is a diagram showing a display example of the card list constituted of the post cards that uses the templates associated with the messages by the server;

FIG. 9 is a flowchart explaining a processing sequence performed by the data display apparatus;

FIG. 10 is a flowchart explaining a processing sequence performed by the server; and

FIG. 11 is a diagram for explaining a hardware structure of each of the data transmission apparatus, the server, and the data display apparatus.

### DESCRIPTION OF PREFERRED EMBODIMENTS

Hereinafter, an information processing apparatus, an information processing method, and a program according to an embodiment of the present invention will be described in detail with reference to the drawings. It should be noted that the description will be given in the order of the following items.

1. Structural example of information processing system that performs message transmission/reception

2. Communication sequence example between apparatuses that perform message transmission/reception

3. Display data in data display apparatus and example of processing with respect to display data

4. Example of processing that uses application setting card

5. Other card list display examples

6. Regarding processing sequence of each apparatus

7. Regarding hardware structure of each apparatus

(1. Structural Example of Information Processing System that Performs Message Transmission/Reception)

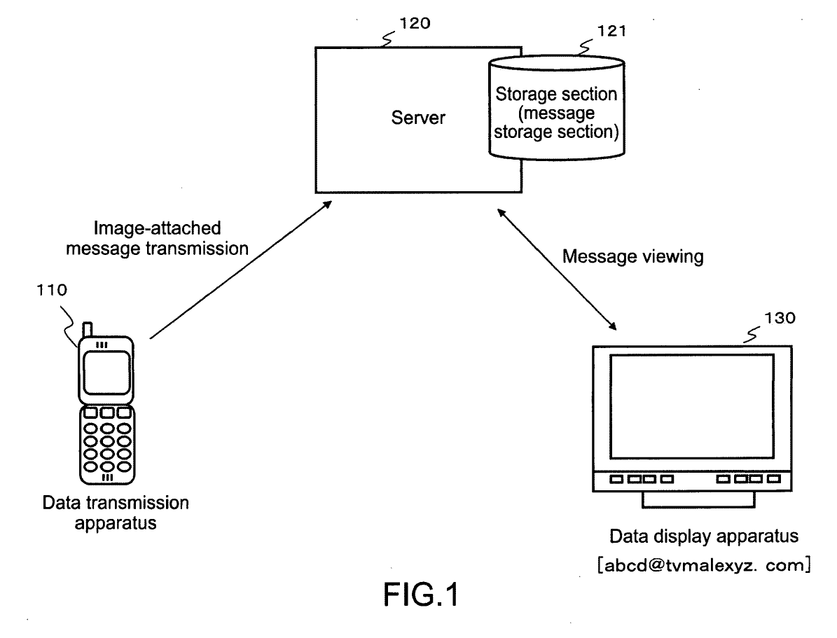

FIG. 1 is a diagram showing a structural example of an information processing system according to the embodiment of the present invention. As shown in FIG. 1, the information processing system includes a data transmission apparatus 110 such as a cellular phone, a server 120, and a data display apparatus 130 such as a television. The data transmission apparatus 110, the server 120, and the data display apparatus 130 each have a function to perform communication via a wireless or wired network.

The data transmission apparatus 110 performs a message transmission processing, and the data display apparatus 130 performs a processing of receiving and displaying a message transmitted from the data transmission apparatus 110. The server 120 performs a relay processing of a message between the data transmission apparatus 110 and the data display apparatus 130.

The data transmission apparatus 110 has a camera function for taking a still image, a moving image, or the like and performs a processing of attaching a taken image to the message, setting an address of a message transmission destination, and transmitting the message. In FIG. 1, an apparatus set as the message transmission destination is the data display apparatus 130.

The data transmission apparatus 110 creates an image-attached message in accordance with a predetermined format and transmits the message. The message format is a format to which the following information can be input or set, for example.

Message transmission destination information (To): for example, “Grandpa and grandma”

Message transmission source information (From): for example, “Keiko”

Message main body: for example, “How are you . . . ”

Image attached to message: for example, one to three pictures

Message transmission source address

Message transmission destination address

The data transmission apparatus 110 creates the image-attached message in accordance with the predetermined format as described above and transmits the message.

The transmitted message is received by the server 120. Upon reception of the transmitted message from the data transmission apparatus 110, the server 120 stores the received message in a storage section 121 thereof. To the message transmitted by the data transmission apparatus 110, the message transmission destination address that indicates the message transmission destination is set. The server 120 stores received messages in the storage section 121 for each message transmission destination address.

The storage section 121 managed by the server 120 has storage areas previously sectioned for each message transmission destination address, and the server 120 organizes the received messages for each message transmission destination address and stores the messages in the storage section 121. It should be noted that at least one piece of image data is attached to each of the received messages.

The data display apparatus 130 is an apparatus having the message transmission destination address that is set to the transmitted message of the data transmission apparatus 110. The data display apparatus 130 holds, in a storage section thereof, a message processing application that is a program for receiving and viewing the message.

By performing the message processing application, the data display apparatus 130 can obtain, from the server 120, the message that the server 120 has received, and can display the message. It should be noted that the data display apparatus 130 and the server 120 are connected with each other via a network such as the Internet.

As a preparation for performing the message processing application, the data display apparatus 130 performs, on the server 120, a service registration processing including various setting processings such as registration of an address of the data display apparatus 130.

For example, as shown in FIG. 1, an address of “abcd@tvmalexyz.com” is registered to the server 120 as the address of the data display apparatus 130. The server 120 secures a message storage area in the storage section 121 for each address registered.

The server 120 confirms the message transmission destination address of the message transmitted from the data transmission apparatus 110. When the message transmission destination address coincides with an address registered, the server 120 stores data of the received message in the storage section 121.

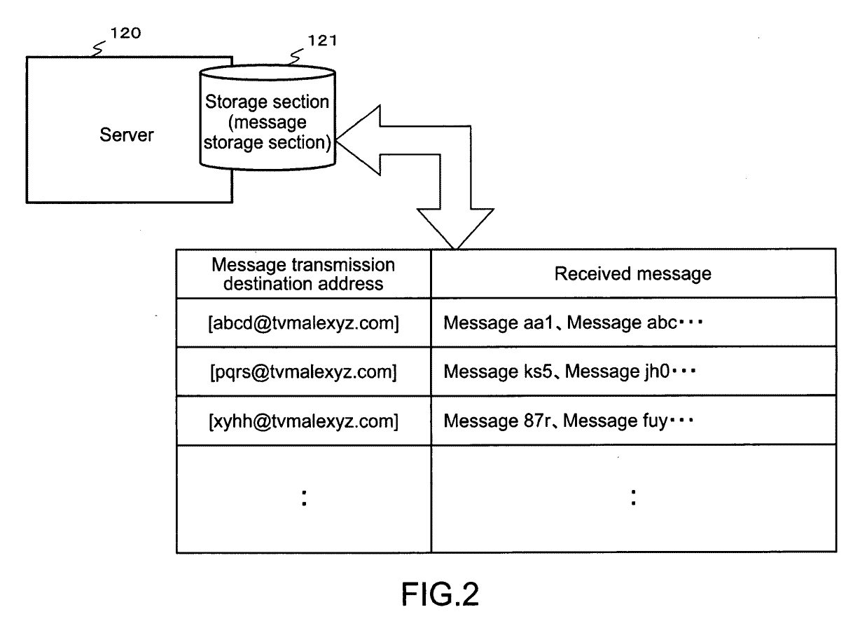

FIG. 2 is a diagram showing a message storage example of the storage section 121. As shown in FIG. 2, the server 120 secures the message storage areas in the storage section 121 for each message transmission destination address registered, and stores the received message in the storage area corresponding to the message transmission destination address.

The data display apparatus 130 performs a polling processing to access the server 120 at predetermined time intervals and confirms whether a new message has reached the apparatus itself (data display apparatus 130). In a case where the new message has reached the apparatus itself (data display apparatus 130), the server 120 notifies the data display apparatus 130 of the fact that the new message has reached the data display apparatus 130 and displays the notification of “you've got a new mail” on the data display apparatus 130, for example.

For example, the user who is watching a TV program on the data display apparatus 130 gets the notification and can confirm that the new message has arrived. When the user wants to view the message, a message processing application is started, and the message stored in the storage section 121 of the server 120 is obtained and displayed.

It should be noted that, regardless of whether the new message has arrived or not, the data display apparatus 130 can start the message processing application at an arbitrary timing and obtain and display the message stored in the storage section 121 of the server 120.

The server 120 creates and provides display data (post card) in a form in which a read message whose content has already been confirmed by the user on the data display apparatus 130 side and an unread message whose content is not confirmed yet are distinguished from each other. A specific example of the display data will be described in detail below. The read message is provided to the data display apparatus 130 as the post card (A side of post card) in which a message main body (text) included in the message and an image such as a picture attached to the message are disposed on a predetermined template, for example.

Further, the unread message is provided to the data display apparatus 130 as display data in a form of the post card (B side of post card) in which only the following message transmission destination/source information is displayed.

Message transmission destination information (To): for example, “Grandpa and grandma”

Message transmission source information (From): for example, “Keiko”

The specific processing example thereof will be described below.

(2. Communication Sequence Example Between Apparatuses that Perform Message Transmission/Reception)

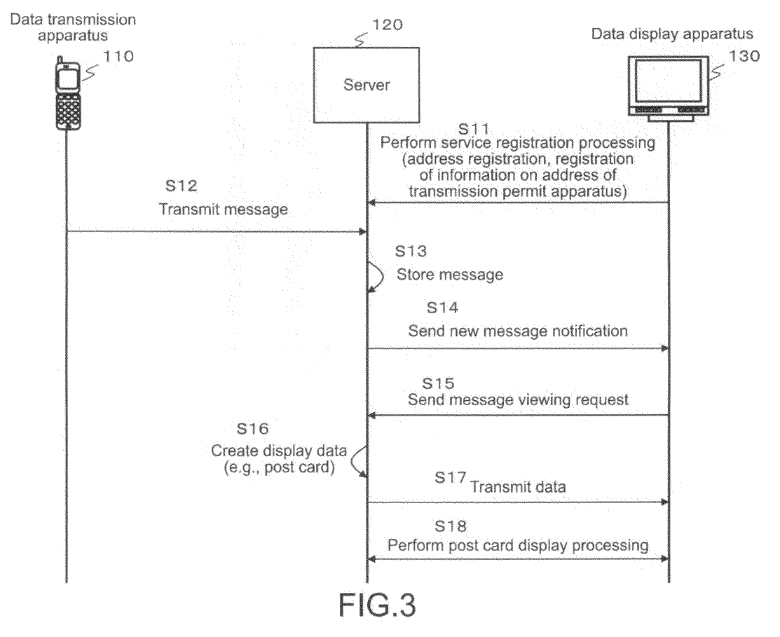

Next, a communication processing sequence that is performed among the data transmission apparatus 110, the server 120, and the data display apparatus 130 will be described with reference to FIG. 3. In FIG. 3, the data transmission apparatus 110, the server 120, and the data display apparatus 130 are displayed as in the case of FIG. 1.

First, in Step S11, the data display apparatus 130 performs, on the server 120, the service registration processing such as the address registration of the data display apparatus 130 itself. It should be noted that in the service registration processing, an address of, e.g., an apparatus that is permitted to transmit a message can be registered in addition to the address of the apparatus itself. For example, when only the data transmission apparatus 110 is registered as the apparatus that is permitted to transmit the message, a message from another apparatus is rejected by the server 120 and is not stored in the storage section 121 of the server 120.

In Step S12, the message is transmitted from the data transmission apparatus 110 such as a cellular phone. The image taken by the data transmission apparatus 110 such as the cellular phone is attached to the message.

The transmitted message is received by the server 120. In Step S13, the server 120 stores the message in the storage section 121 managed by the server 120. For example, as described above with reference to FIG. 2, the message is stored in corresponding one of the storage areas sectioned for each of the message transmission destination addresses.

In Step S14, a new message notification indicating that a new message has arrived is transmitted to the data display apparatus 130 and is displayed on the data display apparatus 130. For example, a notification of “you've got a new mail” is displayed on the data display apparatus 130.

As described above, the data display apparatus 130 performs the polling processing of accessing the server 120 at the predetermined time intervals and confirms whether the new message has reached the apparatus itself (data display apparatus 130). In a case where the fact that the new message has reached the apparatus itself (data display apparatus 130) is confirmed in the polling processing, the new message notification of Step S14 is performed.

The user who is watching the TV program on the data display apparatus 130 gets the notification and confirms that the new message has arrived. When the user wants to view the message, the message processing application is started, and a message viewing request is transmitted to the server 120 in Step S15. It should be noted that, regardless of whether the new message has arrived or not, the data display apparatus 130 starts the message processing application at the arbitrary timing as described above and can transmit the message viewing request to the server 120.

Upon reception of the message viewing request, the server 120 obtains the message from the storage section 121 and creates the display data, that is, the post card to be provided to the data display apparatus 130 in Step S16.

As described above, in the post card as the display data corresponding to the read message, the text included in the message and the image such as the picture attached to the message are disposed on the predetermined template. Meanwhile, the display data corresponding to the unread message indicates only the message transmission destination/source information in a form of the post card.

In Step S17, the display data is provided to the data display apparatus 130. In Step S18, on the data display apparatus 130, the data provided from the server 120, such as the display data constituted of a plurality of post cards, is displayed.

In addition, in Step S18, the user on the data display apparatus 130 side operates an operation section of a remote controller (TV remote controller) compliant with the data display apparatus 130 and performs an opening processing of the unread post card, an enlargement display processing of the read post card, or the like.

(3. Display Data in Data Display Apparatus and Example of Processing with Respect to Display Data)

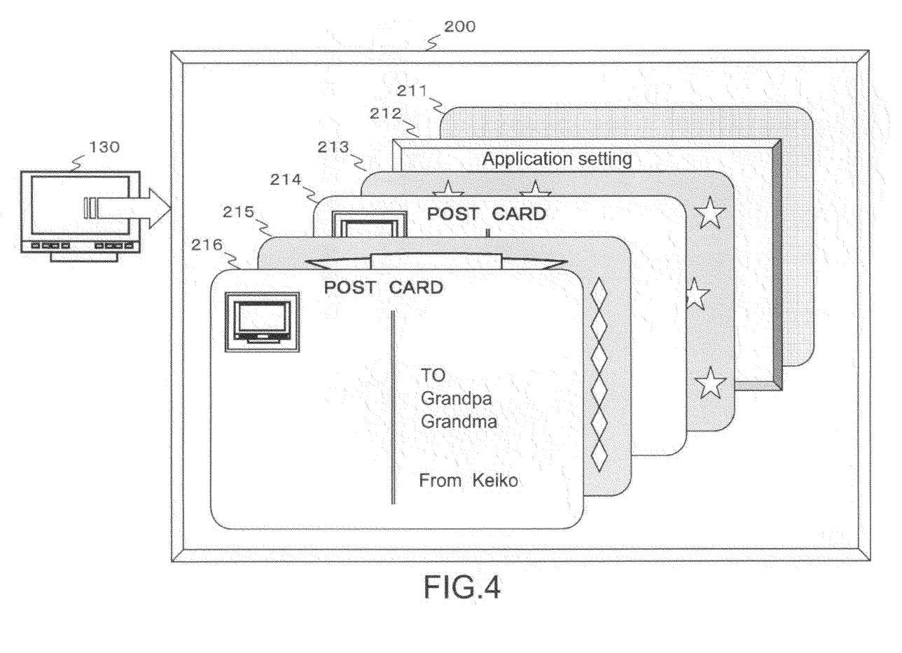

FIG. 4 is a diagram showing an example of the display data provided to the data display apparatus 130 from the server 120. Display data 200 shown in FIG. 4 is an example of data displayed on the display section of the data display apparatus 130 in a case where the data display apparatus 130 makes the message viewing request to the server 120. The display data is a card list in which a plurality of messages are set in the form of post cards. In the plurality of messages, an address corresponding to the data display apparatus 130 is set as an address of the message transmission destination.

As shown in FIG. 4, the card list is displayed in the display form in which the plurality of post cards are overlapped.

The post cards displayed have the following form.

The read messages are post cards in each of which a message main body (text) included in the message and an image such as a picture attached to the message are disposed on the predetermined template.

The read messages correspond to post cards 211, 213, and 215 shown in FIG. 4.

In addition, the unread messages are post cards in each of which only a message transmission destination/source information is displayed.

The unread messages correspond to post cards 214 and 216 shown in FIG. 4.

Further, the card list includes an application setting card 212. The application setting card 212 is selected by the user when a processing of setting the message processing application or changing the setting thereof is performed, for example.

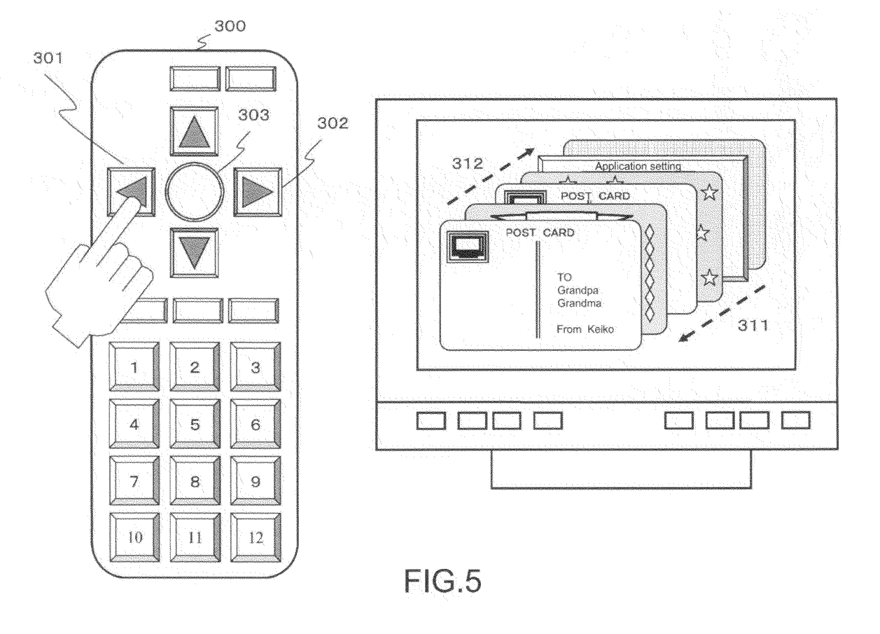

The user on the data display apparatus 130 side operates the remote controller (TV remote controller) compliant with the data display apparatus 130, selects desired data (post card or application setting card) from the card list displayed, and can perform a processing on the selected data. For example, the user operates a remote controller 300 as shown in FIG. 5.

By operating a left button 301 or a right button 302 of the remote controller 300, the data selected from the display data of the data display apparatus 130 can be shifted in a direction indicated by an arrow 311 or 312 shown in FIG. 5. That is, by operating the left button 301 or the right button 302, it is possible to reshuffle the post cards and scroll page by page (i.e., move the post cards to the front by turns). When a decision button 303 is pressed in a state where any piece of data is selected, the processing with respect to the selected data can be started.

For example, any one of the post cards 211, 213, and 215 shown in FIG. 4 is selected and can be enlarged and displayed. Alternatively, the unread messages 214 and 216 are selected and can be subjected to an opening processing. As a result of the opening processing, a document (text) included in the message and an image attached thereto are laid out on the template corresponding to the read message stored in the server 120 and displayed in the form of the post card corresponding to the read message. The post card in which the message main body (text) and the image such as the picture attached to the message are disposed on the predetermined template is displayed.

In a case where the application setting card 212 is selected, the processing of setting the message processing application or changing the setting can be performed, for example.

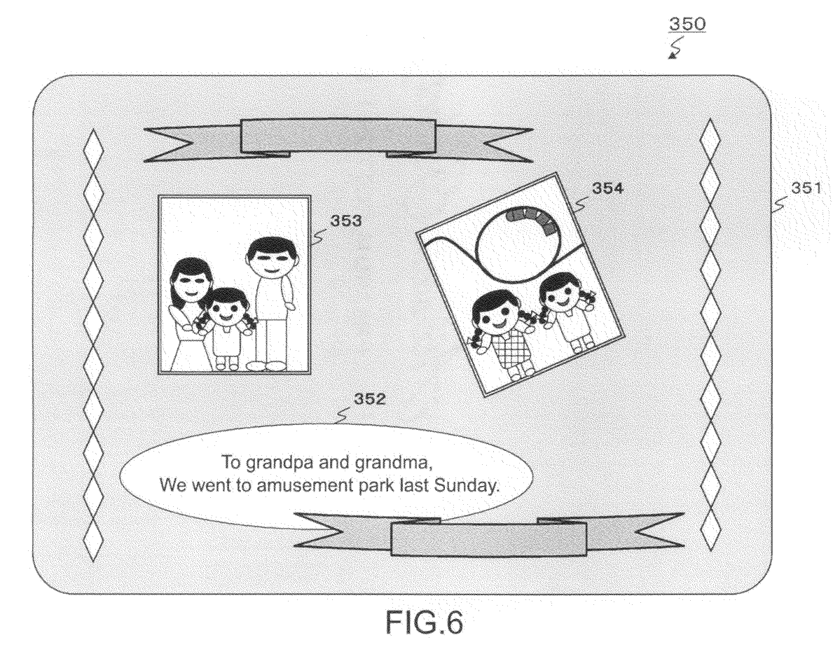

When any one of the opened post cards 211, 213, and 215 shown in FIG. 4 is selected and the decision button is pressed, the selected post card is enlarged and displayed. In this post card, a message main body (text) and an image such as a picture attached to the message are disposed on the predetermined template. FIG. 6 is a diagram showing an example of a post card 350 enlarged and displayed. As shown in FIG. 6, in the post card 350, a message main body (text) 352 included in the message transmitted from the data transmission apparatus 110 and pieces of image data 353 and 354 such as pictures are disposed on a template 351 that is variously designed in advance.

The template is data stored in advance in the storage section 121 of the server 120. The server 120 stores a large number of templates having various designs in the storage section 121 thereof. For example, when the user on the data display apparatus 130 side performs the opening processing of the message, the server 120 selects one from the large number of templates held in the server 120 at random or based on information obtained from the information included in the message, and creates a post card in which the document included in the message and the image attached thereto are disposed on the template.

The server 120 provides the created post card corresponding to the message to the data display apparatus 130. It should be noted that, to the message once opened, identification information (flag) indicating that the message has already been read is set thereafter. The read message is stored in the storage section 121 of the server 120 along with the identification information (flag) indicating that it is the read message and link information with the template used for creating the post card. In the same way, to the unread information, identification information indicating that the message is not yet read is set and stored in the storage section 121. To the unread message, the template displays only the message transmission destination/source information as indicated in the post card 216 shown in FIG. 4 is set as link information.

It should be noted that the creation processing of the post card corresponding to the message by the server 120 may be performed at a timing of the message opening processing performed by the user on the data display apparatus 130 side or at a timing of the message reception processing from the data transmission apparatus 110.

The post card creation processing performed by the server 120 includes a selection processing of the template corresponding to the unread message and a selection processing of the template corresponding to the read message.

The server 120 stores, in the storage section 121 thereof, various kinds of templates having various designs as the templates corresponding to the read message. The server 120 selects one from the large number of templates as the template to be associated with the message. When the template selection processing is executed, the server 120 sets the template selected with respect to the message, which is stored in the storage section 121, as the link information corresponding to the message and stores the template into the storage section. In addition, the template corresponding to the unread message displays only the message transmission destination/source information indicated on the post card 216 shown in FIG. 4. The number of templates may be only one, but the template may be selected from a plurality of templates. Also, the template of the unread message is set as the link information corresponding to the message and stored in the storage section.

For the read message, the server 120 associates, with the message, the link information with the template corresponding to the read message and the identification information (flag) indicating that the message has already been read, and stores the associated information items in the storage section 121.

For the unread message, the server 120 associates, with the message, the link information with the template corresponding to the unread message and the identification information (flag) indicating that the message is not yet read, and stores the associated information items in the storage section 121.

It should be noted that, for the unread message, the template corresponding to the unread message may be selected in advance in order to use the template after the opening processing. In this case, link information with the template corresponding to the read message, which is selected in advance, may be stored in the storage section 121 with the link information being associated with the unread message.

In the case where the card list shown in FIG. 4 is created, the server 120 references the identification information (flag) corresponding to each message and determines the display form.

That is, the server 120 creates the display data in the different forms of the post cards for each of the read message and the unread message and provides the display data to the data display apparatus 130. Specifically, the read message is indicated on the post card in which the message main body (text) and the image data such as a picture are laid out on the template corresponding to the read message. Meanwhile, the unread message is indicated on the post card in which the template that displays only the message transmission destination/source information is used.

In the case where the user on the data display apparatus 130 side performs the opening processing on the unread message, the server 120 performs the following processing.

That is, in a case where the template corresponding to the read message has already been associated with the message as the link data, the server uses the template corresponding to the read message associated, creates the post card in which the message main body (text) and the image are disposed on the template, and provides the post card to the data display apparatus 130. In addition, the server 120 sets the identification information (flag) for judging whether the message is opened or unread to the opened state and stores the identification information in the storage section 121.

Further, in a case where the template corresponding to the read message linked to the newly opened message is not set at a time when the user on the data display apparatus 130 side performs the opening processing of the unread message, the server 120 performs the following processing.

The server 120 performs the selection processing of the template corresponding to the read message, which corresponds to the message that has been newly subjected to the opening processing. Then, the server 120 creates, by using the selected template, the post card in which the message main body (text) included in the message and the image are disposed on the template and provides the post card to the data display apparatus 130. In addition, the server 120 sets the link information indicating that the selected template is used as the template corresponding to the message, sets the identification information (flag) for judging whether the message is opened/unread to the opened state, and stores the set information in the storage section 121.

The message transmitted to the data display apparatus 130 is subjected to the above-described processings and displayed as the card list in which the plurality of post cards are overlapped as shown in FIG. 4.

The user on the data display apparatus 130 side can sequentially select one from the plurality of post cards by operating the remote controller 300 described above with reference to FIG. 5 and enlarge and display the post card. In this case, as to the read message, it is possible to confirm the message main body included in the message and the image such as the picture in the form of the post card without performing a reopening processing of the message.

In other words, only by selecting the post card by using the left button 301 or the right button 302 of the remote controller 300 and operating the decision button 303, it is possible to confirm the message main body included in the message and the image such as the picture attached thereto (shown in FIG. 6) in the form of the post card. The user can confirm the message main body and the image attached to the message without performing the reopening processing of the message, with the result that the burden on the user can be reduced.

(4. Example of Processing that Uses Application Setting Card)

Next, a description will be given on a processing in a case where the application setting card 212 shown in FIG. 4 is selected. As in the case of the post card selection processing, when the user selects the post card by using the left button 301 or the right button 302 of the remote controller 300 and operates the decision button 303, the application setting card 212 shown in FIG. 4 can be selected, to thereby start the processing.

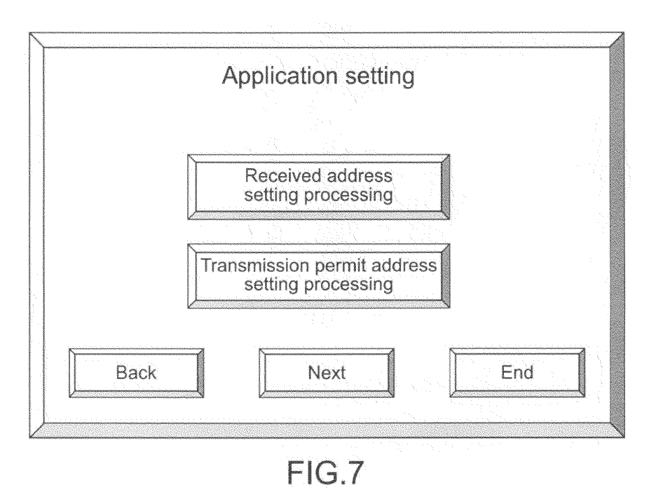

When the application setting card 212 is selected and the processing is started, the application setting card 212 is enlarged and displayed. FIG. 7 is a diagram showing an example of enlargement display of the application setting card.

The application setting card has a structure as shown in FIG. 7, for example. As shown in FIG. 7, a screen for changing the setting of the application, such as a “reception address setting processing” and a “transmission permit address setting processing”, is displayed.

The user on the data display apparatus 130 side can perform various settings by using the application setting screen through the communication between the data display apparatus 130 and the server 120. In this processing, the user on the data display apparatus 130 side also operates only the buttons of the remote controller 300 shown in FIG. 5 to perform the various settings.

For example, in the screen shown in FIG. 7, items of the “reception address setting processing” to an “end” is sequentially selected by using the left button 301 or the right button 302 of the remote controller 300. When an item is selected and the decision button 303 is operated, the processing selected is executed. For example, when the “transmission permit address setting processing” is selected and the decision button 303 is operated, a specific processing execution screen for executing the “transmission permit address setting processing” is displayed, and the processing can be executed.

As described above, the application setting processing can be executed in the same way as the post card selection processing. Therefore, even children or the elderly who have never operated a PC or the like can easily perform the application setting.

### (5. Other Card List Display Examples)

In FIG. 4, an example of the display form of the card list is shown. Basically, other settings may be applied as long as three types of data items of (a) the read messages, (b) the unread messages, and (c) the application setting cards can be distinguished from one another. In other words, those items of (a) to (c) may be displayed in the different display forms so that the user can distinguish the data items of (a) to (c).

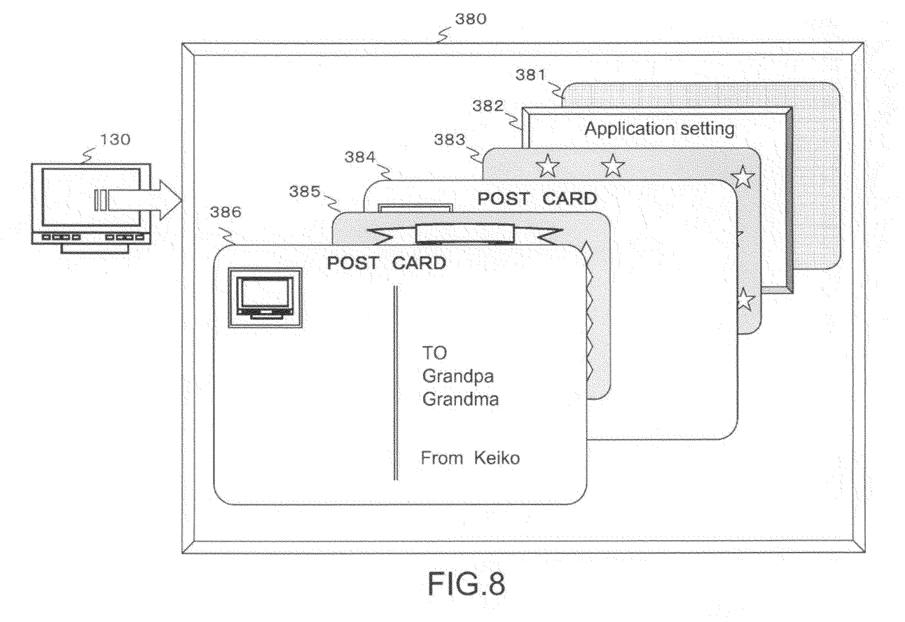

For example, like display data 380 shown in FIG. 8, in order to stand out post cards 384 and 386 corresponding to the unread messages from the other card data items, those post cards 384 and 386 corresponding to the unread messages may be set to have a larger size than the other card data items, i.e., post cards 381, 383, and 385 that correspond to the read messages an application setting card 382. Alternatively, various other display forms can be applied. Specifically, for example, the post cards corresponding to the unread messages may be displayed in a different display color or a different luminance, or may be blinked.

### (6. Regarding Processing Sequence of Each Apparatus)

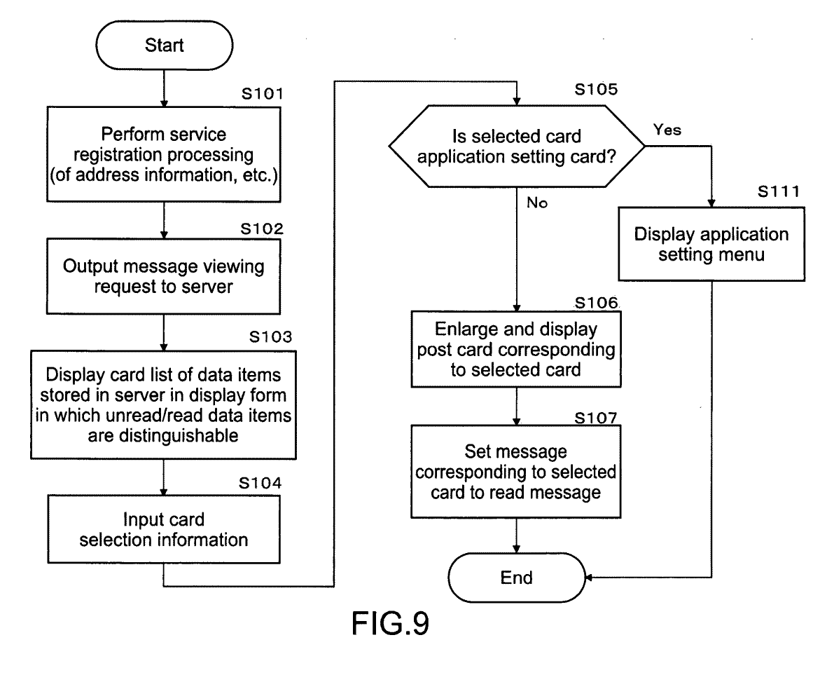

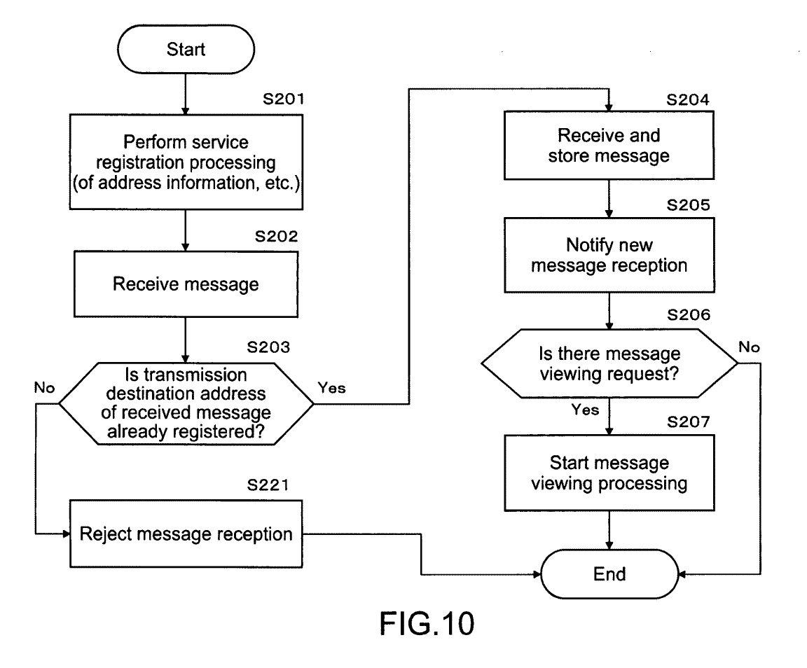

Next, a description will be given on a processing sequence of the data display apparatus 130 and a processing sequence of the server 120 with reference to the flowcharts of FIGS. 9 and 10, respectively.

First, the processing sequence of the data display apparatus 130 will be described with reference to the flowchart of FIG. 9. This process of the flowchart is performed by executing the message processing application that is a program stored in the storage section of the data display apparatus 130 by a controller (CPU) of the data display apparatus 130.

In Step S101, the data display apparatus 130 performs the service registration processing for receiving a message transmission/reception service. Specifically, this processing includes an address registration processing corresponding to the data display apparatus 130, a setting processing of a communication permit address, or the like executed through the communication with the server 120. It should be noted that this processing is an initial setting processing, so it is only necessary to be executed once.

The process of Step S102 and subsequent thereto is performed in a case where the message to the data display apparatus 130 is viewed.

In Step S102, the data display apparatus 130 outputs the message viewing request to the server 120. In response to the request, the server 120 obtains the message to the data display apparatus 130 and provides, to the data display apparatus 130, the card list (see, FIG. 4) including the display data in the post card form that uses the templates corresponding to the messages.

In Step S103, the data display apparatus 130 receives the card list from the server 120 and displays the card list on the display section. The display data is the card list in which the post cards described above with reference to FIG. 4 are overlapped, that is, the card list constituted of the post cards having different display forms so that the unread messages and the read messages can be distinguished from each other. In addition, the display data is constituted of the post cards including the application setting card.

In Step S104, the user on the data display apparatus 130 side operates the remote controller (see, FIG. 5) or the like to select a card from the card list. As described above with reference to FIG. 5, the user selects a card by operating the left or right button of the remote controller, and operates the decision button to start the processing of the selected card.

In Step S105, it is judged whether the selected card is the application setting card or not. In a case where the selected card is the application setting card, the process proceeds to Step S111. In Step S111, the enlargement display of the application setting card is performed. For example, the application setting card described above with reference to FIG. 7 is displayed. After that, the application setting processing in response to the operation by the user is carried out.

On the other hand, in Step S105, in a case where it is judged that the selected card is not the application setting card, the process proceeds to Step S106. That is, the processing when the post card is selected is performed.

In the case where the selected card is the post card, in Step S106, the enlargement display processing of the selected post card is performed. For example, the post card display processing described above with reference to FIG. 6 is performed. The post card has the structure in which the message main body (text) and the image data such as the picture that are included in the message transmitted by the data transmission apparatus 110 are disposed on the template selected by the server.

In Step S107, the identification information (flag) associated with the message corresponding to the post card that has been subjected to the enlargement display processing is set to the identification information indicating that the message has already been read. The information is recorded as the identification information associated with the message stored in the storage section 121 of the server 120. It should be noted that the identification information is changed when the unread message is opened. In a case where the post card corresponding to the unread message is selected and subjected to the enlargement display, the process of Step S107 can be omitted.

Next, with reference to the flowchart shown in FIG. 10, the processing sequence of the server 120 will be described.

In Step S201, an initial setting processing for starting a service with respect to the data display apparatus 130 is performed. The server 120 communicates with the data display apparatus 130 that is to get the message transmission/reception service to perform the service registration processing. This processing includes the address registration processing for the data display apparatus 130, the communication permit address setting processing, and the like, and corresponds to the processing in Step S101 in the flowchart shown in FIG. 9. In performing the service registration processing, the server 120 secures, in the storage section, a message storage area corresponding to the address of the data display apparatus 130. This processing is the initial setting processing, so it is only necessary to be executed once.

In Step S202, the server 120 receives a message from the data transmission apparatus 110. The received message is the message based on the predetermined format as described above and is constituted of the following pieces of data.

Message transmission destination information (To): for example, “Grandpa and grandma”

Message transmission source information (From): for example, “Keiko”

Message main body: for example, “How are you . . . ”

Image attached to message: for example, one to three pictures

Message transmission source address

Message transmission destination address

Next, in Step S203, the server 120 judges whether the address of the message transmission destination, which is set to the message received coincides with the registered address. In a case where the address does not coincide with the registered address, the process proceeds to Step S221, and the reception of the message is rejected, to terminate the processing.

On the other hand, in Step S203, in a case where the message transmission destination address set to the received message coincides with the registered address, the process proceeds to Step S204.

In Step S204, the server 120 stores the received message in the storage section 121. As described above with reference to FIG. 4, in the storage section 121 managed by the server 120, the message storage area corresponding to each registered address is secured. The server 120 records the message on the message storage area corresponding to the message transmission destination address set to the received message.

It should be noted that, in the case where the server 120 stores the message in the storage section 121, the server 120 sets the identification information (flag) for judging whether the message is read/unread and stores the identification information. In addition, the server 120 sets, as the link information, the template used for displaying the message to the data display apparatus and stores the template.

In Step S205, the server 120 outputs, to the data display apparatus 130, a new message reception notification indicating that a new message has arrived. It should be noted that the notification processing is performed in accordance with the polling processing performed by the data display apparatus 130 as described above, for example.

When detecting that the message viewing request is received from the data display apparatus 130 in Step S206, the server 120 starts a message viewing processing in Step S207.

The message viewing processing in Step S207 includes a processing executed on the server side in association with the processings in the Steps S103 to 5107 on the data display apparatus 130 side, which are shown in FIG. 9.

Specifically, the message viewing processing includes a processing of creating the card list constituted of the post cards and providing to the data display apparatus 130 as described above with reference to FIG. 4, for example.

The post cards each correspond to each of the messages. The read message is displayed as the post card in which the message main body (text) 352 included in the message transmitted from the data transmission apparatus 110 and the image data items 353 and 354 such as the pictures are disposed on the template corresponding to the read message. On the template, the various designs are applied. This example of the post card is shown in FIG. 6.

In addition, the unread message is displayed as the post card in which the message transmission destination information and the message transmission source information are disposed on the template corresponding to the unread message that displays only the message transmission destination information and the message transmission source information. This example of the post card is shown as the post card 216 in FIG. 4.

After that, in accordance with the instruction by the user on the data display apparatus 130 side, the enlargement display processing of the post card, the opening processing of the unread message, the application setting processing that uses the application card, and the like are performed.

It should be noted that in the case where the opening processing of the unread message is performed, the server 120 performs a processing of changing and setting the identification information (flag) of the message stored in the storage section 121 of the server 120 to the identification information (flag) indicating that the message has already read.

### (7. Regarding Hardware Structure of Each Apparatus)

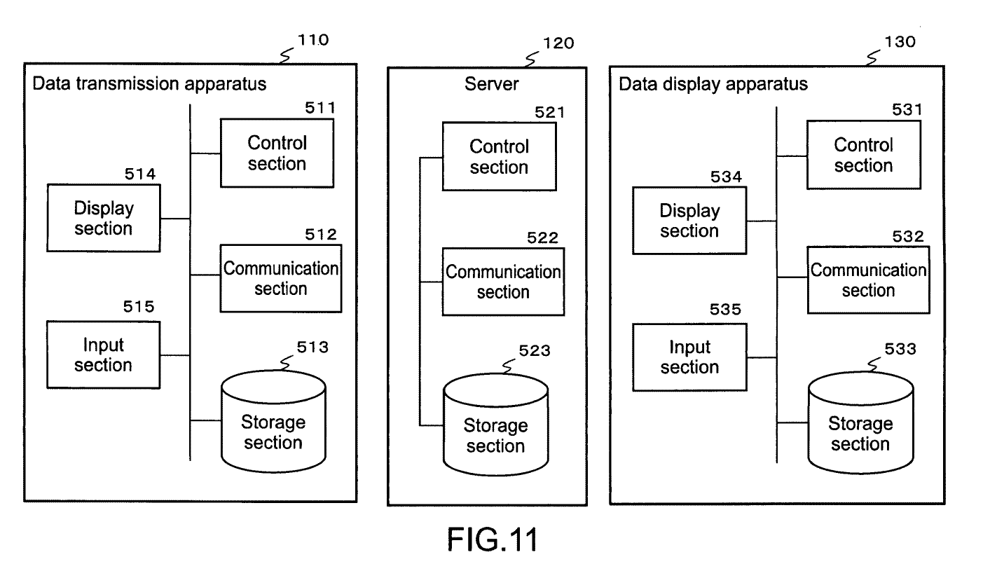

Finally, with reference to FIG. 11, an example of a hardware structure of each of the data transmission apparatus 110, the server 120, and the data display apparatus 130 will be described.

As shown in FIG. 11, the data transmission apparatus 110 includes a control section 511, a communication section 512, a storage section 513, a display section 514, and an input section 515. The control section 511 performs data processings to which various programs are applied. The communication section 512 performs the communication via a network. The storage section 513 stores a program, a parameter, image data, and the like. The display section 514 displays an image or a user interface, for example. The input section 515 inputs information of an operation by the user. It should be noted that, in a case where the information can be input through a UI such as a touch panel UI, the display section is equipped with the input section.

The control section 511 of the data transmission apparatus 110 performs, in response to the user operation through the input section 515, processings of shooting and storing a photograph, creating a message, and transmitting a message to which an image is attached, for example. As described above, the transmission message is a message created in accordance with a format to which the following information can be input or set, for example.

Message transmission destination information (To): for example, “Grandpa and grandma”

Message transmission source information (From): for example, “Keiko”

Message main body: for example, “How are you . . . ”

Image attached to message: for example, one to three pictures

Message transmission source address

Message transmission destination address

Next, the structure of the server 120 will be described. As shown in FIG. 11, the server 120 includes a control section 521, a communication section 522, and a storage section 523 (that corresponds to the storage section 121 shown in FIG. 1). The control section 521 performs data processings to which various programs are applied. The communication section 522 performs the communication via the network. The storage section 523 stores a program, a parameter, a message, an image data, information on a template that is applied to a post card, and the like.

The control section 521 of the server 120 stores the message received from the data transmission apparatus 110 to the storage section 523 and provides, in response to the viewing request from the data display apparatus 130, data that can be displayed in the form of the post card to the data display apparatus 130. In addition, the server 120 sets various attribute information items with respect to the messages stored in the storage section 523, for example, the identification information for judging whether the message is read/unread, the link information with the template, and the like.

Next, the structure of the data display apparatus 130 will be described. As shown in FIG. 11, the data display section 130 includes a control section 531, a communication section 532, a storage section 533, a display section 534, and an input section 535. The control section 531 performs data processings to which various programs are applied. The communication section 532 performs the communication via the network. The storage section 533 stores a program, a parameter, image data, and the like. The display section 534 displays an image or a user interface, for example. The input section 535 inputs information of an operation by the user. It should be noted that the input section 535 corresponds to the remote controller 300 described above with reference to FIG. 5.

In response to the user operation through the input section 535, the control section 531 of the data display apparatus 130 performs various processings of outputting the message viewing request to the server 120, selecting the card from the card list shown in FIG. 4, enlarging and displaying the selected post card, opening the unread message, and setting the application, for example. Those processings are performed by executing the message processing application as the program stored in the storage section 533 by the controller 531 constituted of the CPU and the like.

Heretofore, the embodiment of the present invention is described by using the specific examples. However, those skilled in the art can of course modify or replace the embodiment of the present invention without departing from the gist of the present invention. That is, the embodiment of the present invention is described above as an example, and therefore the present invention should not be subjected to limited interpretation. The gist of the present invention should be understood by taking the appended claims into consideration.

In addition, the series of processings described in this specification can be executed by using hardware, software, or a composite structure of the hardware and software. When the processings are executed by using the software, a program on which the processing sequence is recorded can be installed in a memory in a computer incorporated in a dedicated hardware and executed. Alternatively, the program can be installed in general-purpose computer capable of performing various processings and executed. For example, the program can be recorded on a recording medium in advance and installed to the computer from the recording medium. In addition, the program is received via a network such as a LAN (local area network) or the Internet and can be installed to the recording medium such as a build-in hard disk.

It should be noted that the various processings described in this specification may be executed in the chronological order of the description, or may be executed in parallel or separately, as necessary or depending on the processing abilities of the apparatuses that perform the processings. Further, the system in this specification refers to a logical composite structure of the plurality of apparatuses. Therefore, the apparatuses of the respective structures are not limited to be disposed in the same casing.

As described above, according to the structure of the embodiment of the present invention, in the structure in which the received message is displayed on the display apparatus such as a television, the post card in which the information included in the received message is laid out on the template is obtained from the server and displayed. The post card has the display form that enables the user to distinguish between the read message and the unread message. For example, the read message is displayed as the post card including the message main body and the image data that are included in the message, and the unread message is displayed as the post card including only the message transmission destination/source information. This processing allows the user to easily distinguish between the unread/read messages and to confirm the message main body and the image without performing the reopening processing on the read message.

The present application contains subject matter related to that disclosed in Japanese Priority Patent Application JP 2009-016222 filed in the Japan Patent Office on Jan. 28, 2009, the entire content of which is hereby incorporated by reference.

What is claimed is:

1. An information processing apparatus, comprising:
a display section to display a data;
an input section to input user input information;
a communication section to communicate with a server; and
a control section to control a display of a received message on the display section in accordance with the input information input through the input section, the control section displaying, on the display section, a post card in which information included in the received message is laid out on a template selected in advance by the server, and enabling a user to judge whether the post card corresponds to a read message or an unread message by displaying the post card corresponding to the read message in different display forms from the post card corresponding to the unread message.

2. The information processing apparatus according to claim 1,
wherein the control section displays the read message as the post card that uses a template corresponding to the read message, the template including image data and a message main body in the message that are laid out thereon, and
wherein the control section displays the unread message as the post card that uses a template corresponding to the unread message, the template excluding image data and a message main body in the message.

3. The information processing apparatus according to claim 1,
wherein the control section displays the unread message as the post card including only message transmission destination information and message transmission source information.

4. The information processing apparatus according to claim 1,
wherein the control section displays the post card corresponding to the read message and the post card corresponding to the unread message in different sizes.

5. The information processing apparatus according to claim 1,
wherein the control section displays a plurality of post cards so that the post cards are arranged in a display manner in which at least parts of the plurality of post cards corresponding to a plurality of received messages are overlapped and so that a screen used for setting an application that is a processing program for the message is mixed, as an application setting card, in the plurality of post cards arranged, and
wherein, in accordance with selection and decision information of one of the post card and the application setting card, the control section enlarges one of the post card and the application setting card selected, the selection and decision information being input from the input section.

6. The information processing apparatus according to claim 5,
wherein the control section performs a page scrolling processing of rearranging the post cards in accordance with the input information from the input section with the post cards arranged being displayed on the display section.

7. An information processing apparatus, comprising:
a storage section to store a received message and a template;
a communication section to communicate with a data display apparatus; and
a control section to provide, in response to a message viewing request from the data display apparatus, the received message stored in the storage section, the control section selecting a template corresponding to the received message, associating the selected template with a message, and in response to the message viewing request from the data display apparatus, providing, to the data display apparatus, a post card in which information included in the message is laid out on the selected template.

8. The information processing apparatus according to claim 7,
wherein the control section provides, to the data display apparatus, a read message as the post card that uses a template corresponding to the read message, the template including image data and a message main body in the message that are laid out thereon, and provides, to the data display apparatus, an unread message as the post card that uses a template corresponding to the unread message, the template excluding image data and a message main body in the message.

9. An information processing method executed in an information processing apparatus, comprising:
outputting, by a control section, a message viewing request to a server through a communication section; and
obtaining, by the control section, information on a post card in which information in a received message is laid out on a template from the server and displaying, on a display section, the obtained information as the post card, the post card corresponding to a read message having a different display form and being distinguishable from the post card corresponding to an unread message.

10. A program for causing an information processing apparatus to execute an information processing, the program comprising:
causing a control section to output a message viewing request to a server through a communication section; and
causing the control section to perform a processing of obtaining information on a post card in which information in a received message is laid out on a template from the server and displaying, on a display section, the obtained information as the post card, the post card corresponding to a read message having a different display form and being distinguishable from the post card corresponding to an unread message.
